(19) United States
(12) Patent Application Publication
(10) Pub. No.: US 2018/0032429 A1
(43) Pub. Date: Feb. 1, 2018

(54) TECHNIQUES TO ALLOCATE REGIONS OF A MULTI-LEVEL, MULTI-TECHNOLOGY SYSTEM MEMORY TO APPROPRIATE MEMORY ACCESS INITIATORS

(71) Applicant: Intel Corporation, Santa Clara, CA (US)

(72) Inventors: Min LIU, Portland, OR (US); Zhenlin LUO, Beijing (CN); George VERGIS, Portland, OR (US); Murugasamy K. NACHIMUTHU, Beaverton, OR (US); Mohan J. KUMAR, Aloha, OR (US); Ross E. ZWISLER, Lafayette, CO (US)

(21) Appl. No.: 15/224,134

(22) Filed: Jul. 29, 2016

(51) Int. Cl. G06F 12/02; G06F 12/0873; G06F 12/0871; G06F 12/084; G06F 12/0842

(52) U.S. Cl. CPC G06F 12/023; G06F 12/084; G06F 12/0842; G06F 12/0871; G06F 12/0873; G06F 2212/1016; G06F 2212/271; G06F 2212/305; G06F 2212/604

(57) ABSTRACT

A method is described. The method includes recognizing different latencies and/or bandwidths between different levels of a system memory and different memory access requestors of a computing system. The system memory includes the different levels and different technologies. The method also includes allocating each of the memory access requestors with a respective region of the system memory having an appropriate latency and/or bandwidth.

### FIELD OF INVENTION

The field of invention pertains generally to computing systems, and, more specifically, to techniques to allocate regions of a multi-level, multi-technology system memory to appropriate memory access initiators.

### BACKGROUND

A pertinent issue in many computer systems is the use of system memory. Here, as is understood in the art, a computing system operates by executing program code stored in system memory and reading/writing data that the program code operates on from/to system memory. As such, system memory is heavily utilized with many program code and data reads as well as many data writes over the course of the computing system's operation. Finding ways to improve system memory accessing performance is therefore a motivation of computing system engineers.

Currently, the Advanced Configuration and Power Interface (ACPI) provides for a System Locality Information Table (SLIT) that describes distance between nodes in a multi-processor computer system, and, a Static Resource Affinity Table (SRAT) that associates each processor with a block of memory. The SLIT and SRAT are ideally used to couple processors with appropriately distanced memory banks so that desired performance levels for the applications that run on the processors can be achieved.

However, new system memory advances are introducing not only different system memory technologies but also different system memory architectures into a same comprehensive system memory. The current SLIT and SRAT tables do not take into account these specific newer system memory features.

### FIGURES

A better understanding of the present invention can be obtained from the following detailed description in conjunction with the following drawings, in which:

FIG. 1 shows a multi-level memory implementation;

FIG. 2 shows a multi-processor computer system;

FIG. 3a shows different memory levels organized by latency from the perspective of a requestor;

FIGS. 3b(i) and 3b(ii) show breakdowns for different 2LM components of the system memory of the system of FIG. 2;

FIG. 4 shows different configurations of different applications on different platforms with different system memory levels;

FIGS. 5a and 5b show a root complex of attributes to align system memory requestors with appropriate system memory domains;

FIG. 6 shows a method to configure a computing system;

FIG. 7 shows an embodiment of a computing system.

### DETAILED DESCRIPTION

### 1.0 Multi-Level System Memory

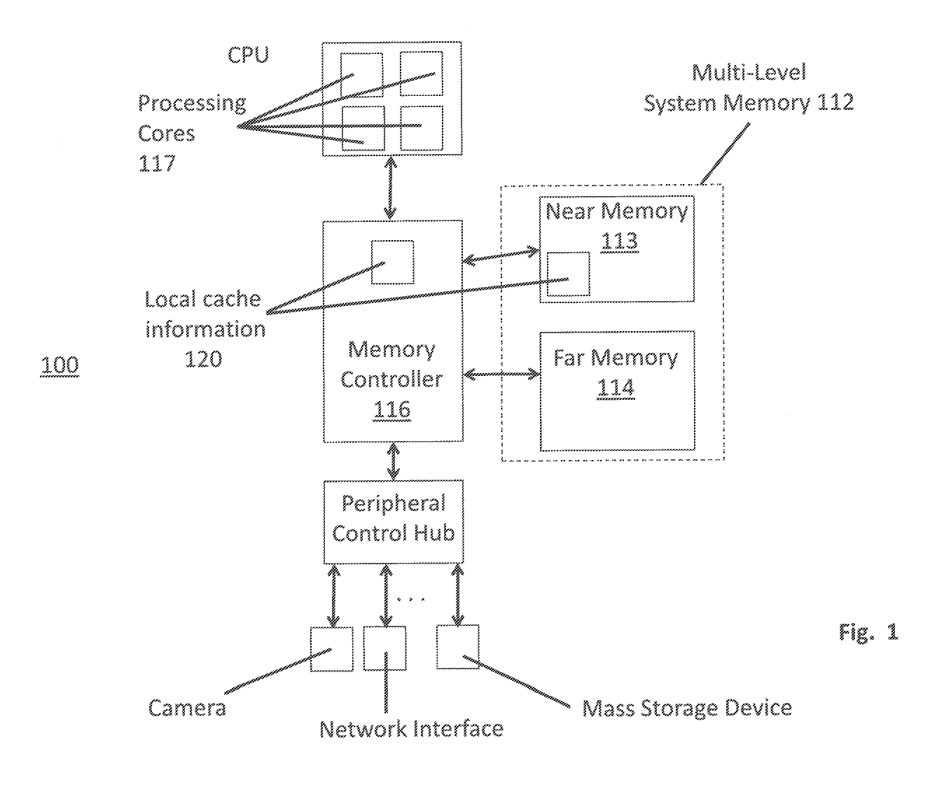

One of the ways to improve system memory performance is to have a multi-level system memory. FIG. 1 shows an embodiment of a computing system 100 having a multi-tiered or multi-level system memory 112. According to various embodiments, a smaller, faster near memory 113 may be utilized as a cache for a larger far memory 114.

The use of cache memories for computing systems is well-known. In the case where near memory 113 is used as a cache, near memory 113 is used to store an additional copy of those data items in far memory 114 that are expected to be more frequently called upon by the computing system. By storing the more frequently called upon items in near memory 113, the system memory 112 will be observed as faster because the system will often read items that are being stored in faster near memory 113. For an implementation using a write-back technique, the copy of data items in near memory 113 may contain data that has been updated by the CPU, and is thus more up-to-date than the data in far memory 114. The process of writing back ‘dirty’ cache entries to far memory 114 ensures that such changes are not lost.

According to various embodiments, near memory cache 113 has lower access times than the lower tiered far memory 114 region. For example, the near memory 113 may exhibit reduced access times by having a faster clock speed than the far memory 114. Here, the near memory 113 may be a faster (e.g., lower access time), volatile system memory technology (e.g., high performance dynamic random access memory (DRAM)) and/or SRAM memory cells co-located with the memory controller 116. By contrast, far memory 114 may be either a volatile memory technology implemented with a slower clock speed (e.g., a DRAM component that receives a slower clock) or, e.g., a non volatile memory technology that is slower (e.g., longer access time) than volatile/DRAM memory or whatever technology is used for near memory.

For example, far memory 114 may be comprised of an emerging non volatile random access memory technology such as, to name a few possibilities, a phase change based memory, a three dimensional crosspoint memory, “write-in-place” non volatile main memory devices, memory devices that use chalcogenide, multiple level flash memory, multi-threshold level flash memory, a ferro-electric based memory (e.g., FRAM), a magnetic based memory (e.g., MRAM), a spin transfer torque based memory (e.g., STT-RAM), a resistor based memory (e.g., ReRAM), a Memristor based memory, universal memory, Ge2Sb2Te5 memory, programmable metallization cell memory, amorphous cell memory, Ovshinsky memory, etc. Any of these technologies may be byte addressable so as to be implemented as a main/system memory in a computing system.

Emerging non volatile random access memory technologies typically have some combination of the following: 1) higher storage densities than DRAM (e.g., by being constructed in three-dimensional (3D) circuit structures (e.g., a crosspoint 3D circuit structure)); 2) lower power consumption densities than DRAM (e.g., because they do not need refreshing); and/or, 3) access latency that is slower than DRAM yet still faster than traditional non-volatile memory technologies such as FLASH. The latter characteristic in particular permits various emerging non volatile memory technologies to be used in a main system memory role rather than a traditional mass storage role (which is the traditional architectural location of non volatile storage).

Regardless of whether far memory 114 is composed of a volatile or non volatile memory technology, in various embodiments far memory 114 acts as a true system memory in that it supports finer grained data accesses (e.g., cache lines) rather than larger based “block” or “sector” accesses associated with traditional, non volatile mass storage (e.g., solid state drive (SSD), hard disk drive (HDD)), and/or, otherwise acts as an (e.g., byte) addressable memory that the program code being executed by processor(s) of the CPU operate out of.

Because near memory 113 acts as a cache, near memory 113 may not have formal addressing space. Rather, in some cases, far memory 114 defines the individually addressable memory space of the computing system's main memory. In various embodiments near memory 113 acts as a cache for far memory 114 rather than acting a last level CPU cache. Generally, a CPU cache is optimized for servicing CPU transactions, and will add significant penalties (such as cache snoop overhead and cache eviction flows in the case of cache hit) to other system memory users such as Direct Memory Access (DMA)-capable devices in a Peripheral Control Hub. By contrast, a memory side cache is designed to handle, e.g., all accesses directed to system memory, irrespective of whether they arrive from the CPU, from the Peripheral Control Hub, or from some other device such as display controller.

In various embodiments, system memory may be implemented with dual in-line memory module (DIMM) cards where a single DIMM card has both volatile (e.g., DRAM) and (e.g., emerging) non volatile memory semiconductor chips disposed in it. The DRAM chips effectively act as an on board cache for the non volatile memory chips on the DIMM card. Ideally, the more frequently accessed cache lines of any particular DIMM card will be accessed from that DIMM card's DRAM chips rather than its non volatile memory chips. Given that multiple DIMM cards may be plugged into a working computing system and each DIMM card is only given a section of the system memory addresses made available to the processing cores 117 of the semiconductor chip that the DIMM cards are coupled to, the DRAM chips are acting as a cache for the non volatile memory that they share a DIMM card with rather than as a last level CPU cache.

In other configurations DIMM cards having only DRAM chips may be plugged into a same system memory channel (e.g., a DDR channel) with DIMM cards having only non volatile system memory chips. Ideally, the more frequently used cache lines of the channel are in the DRAM DIMM cards rather than the non volatile memory DIMM cards. Thus, again, because there are typically multiple memory channels coupled to a same semiconductor chip having multiple processing cores, the DRAM chips are acting as a cache for the non volatile memory chips that they share a same channel with rather than as a last level CPU cache.

In yet other possible configurations or implementations, a DRAM device on a DIMM card can act as a memory side cache for a non volatile memory chip that resides on a different DIMM and is plugged into a different channel than the DIMM having the DRAM device. Although the DRAM device may potentially service the entire system memory address space, entries into the DRAM device are based in part from reads performed on the non volatile memory devices and not just evictions from the last level CPU cache. As such the DRAM device can still be characterized as a memory side cache.

In another possible configuration, a memory device such as a DRAM device functioning as near memory 113 may be assembled together with the memory controller 116 and processing cores 117 onto a single semiconductor device or within a same semiconductor package. Far memory 114 may be formed by other devices, such as slower DRAM or non-volatile memory and may be attached to, or integrated in that device.

In still other embodiments, at least some portion of near memory 113 has its own system address space apart from the system addresses that have been assigned to far memory 114 locations. In this case, the portion of near memory 113 that has been allocated its own system memory address space acts, e.g., as a higher priority level of system memory (because it is faster than far memory) rather than as a memory side cache. In other or combined embodiments, some portion of near memory 113 may also act as a last level CPU cache.

In various embodiments when at least a portion of near memory 113 acts as a memory side cache for far memory 114, the memory controller 116 and/or near memory 113 may include local cache information (hereafter referred to as “Metadata”) 120 so that the memory controller 116 can determine whether a cache hit or cache miss has occurred in near memory 113 for any incoming memory request.

In the case of an incoming write request, if there is a cache hit, the memory controller 116 writes the data (e.g., a 64-byte CPU cache line or portion thereof) associated with the request directly over the cached version in near memory 113. Likewise, in the case of a cache miss, in an embodiment, the memory controller 116 also writes the data associated with the request into near memory 113 which may cause the eviction from near memory 113 of another cache line that was previously occupying the near memory 113 location where the new data is written to. However, if the evicted cache line is “dirty” (which means it contains the most recent or up-to-date data for its corresponding system memory address), the evicted cache line will be written back to far memory 114 to preserve its data content.

In the case of an incoming read request, if there is a cache hit, the memory controller 116 responds to the request by reading the version of the cache line from near memory 113 and providing it to the requestor. By contrast, if there is a cache miss, the memory controller 116 reads the requested cache line from far memory 114 and not only provides the cache line to the requestor (e.g., a CPU) but also writes another copy of the cache line into near memory 113. In various embodiments, the amount of data requested from far memory 114 and the amount of data written to near memory 113 will be larger than that requested by the incoming read request. Using a larger data size from far memory or to near memory increases the probability of a cache hit for a subsequent transaction to a nearby memory location.

In general, cache lines may be written to and/or read from near memory and/or far memory at different levels of granularity (e.g., writes and/or reads only occur at cache line granularity (and, e.g., byte addressability for writes/or reads is handled internally within the memory controller), byte granularity (e.g., true byte addressability in which the memory controller writes and/or reads only an identified one or more bytes within a cache line), or granularities in between.) Additionally, note that the size of the cache line maintained within near memory and/or far memory may be larger than the cache line size maintained by CPU level caches.

Different types of near memory caching implementation possibilities exist. Examples include direct mapped, set associative, fully associative. Depending on implementation, the ratio of near memory cache slots to far memory addresses that map to the near memory cache slots may be configurable or fixed.

### 2.0 Multiple Processor Computing Systems With Multi-Level System Memory

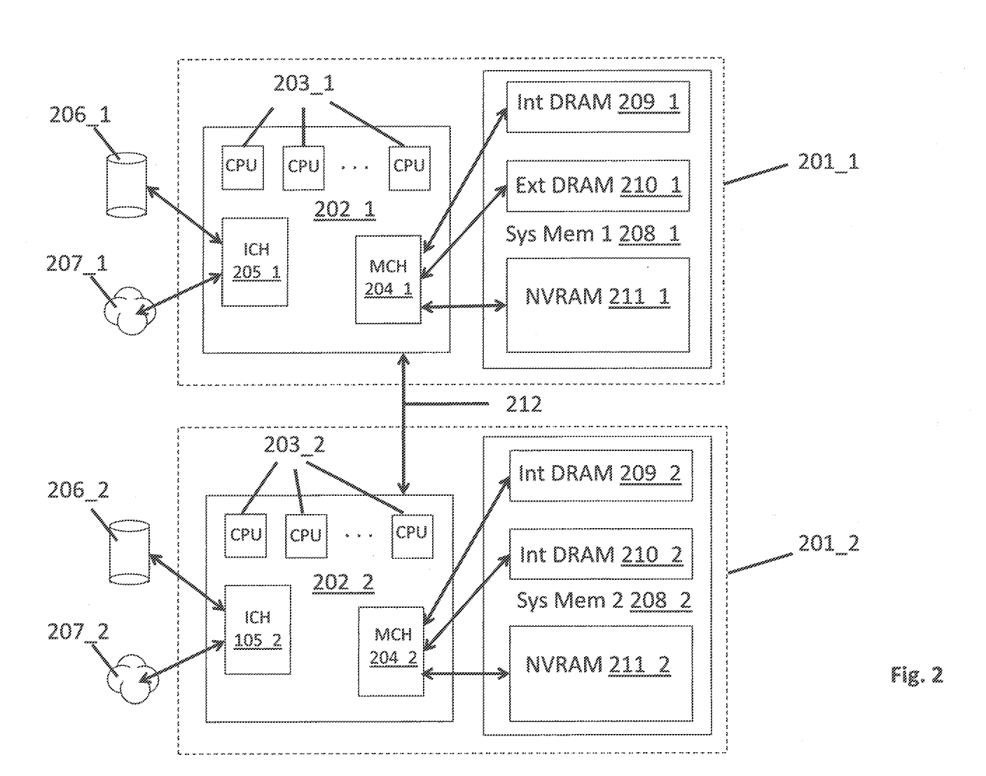

FIG. 2 shows an exemplary architecture for a multi-processor computing system. As observed in FIG. 2, the multi-processor computer system includes two platforms 201_1, 201_2 interconnected by a communication link 212. Both platforms include a respective processor 202_1, 202_2 each having multiple CPU cores 203_1, 203_2. The processors 202_1, 202_2 of the exemplary system of FIG. 2 each include an I/O control hub 205_1, 205_2 that permit each platform to directly communicate with some form of I/O such as a network 206_1, 206_2 or a mass storage device 207_1, 207_2 (e.g., a block/sector based disk drive, solid state drive, non volatile storage device, or some combination thereof). As with the system in FIG. 1, an I/O control hub is free to issue a request directly to its local memory control hub. Platforms 205_1, 205_2 may be designed such that I/O control hubs 205_1, 205_2 are directly coupled to their local CPU cores 203_1, 203_2 and/or their local memory control hub (MCH) 204_1, 204_2.

Note that a wide range of different systems can loosely or directly fit the exemplary architecture of FIG. 2. For example, platforms 201_1 and 201_2 may be different multi-chip modules that plug-into same sockets on a same motherboard. Here, link 212 corresponds to a signal trace in the motherboard. By contrast, platform 201_1 may be a first multi-chip module that plugs into a first mother board and platform 201_1 may be a second multi-chip module that plugs into a second, different mother board. In this case, the system includes, e.g., multiple motherboards each having multiple platforms and link 212 corresponds to a backplane connection or other motherboard-to-motherboard connection within a same hardware box chassis. In yet another embodiment, platforms 201_1, 201_2 are within different hardware box chassis and link 212 corresponds to a local area network link or even a wide area network link (or even an Internet connection).

The multi-processor system of FIG. 2 is also somewhat simplistic in that only two platforms 201_1, 201_2 are depicted. In various implementations, a multi-processor computing system may include many platforms where link 212 is replaced by an entire network that communicatively couples the various platforms. The network could be composed of various links of all kinds of different distances (e.g., any one or more of intra-motherboard, backplane, local area network and wide area network). Multi-processor systems may also include platforms that are functionally decomposed as compared to the platforms observed in FIG. 2. For example, some platforms may only include CPU cores, other platforms may only include a memory control hub and system memory slice, whereas other platforms may include an I/O control hub (in which case, e.g., an I/O hub can communicate directly with a processing core). Various combinations of these sub components may also be combined in various ways to form other types of platforms. In various implementations, however, the various platforms are interconnected through a network as described just above. For simplicity, the remainder of the discussion will largely refer to the multi-processor system of FIG. 2 because pertinent points of the instant application can largely be described from it.

Each platform 201_1, 201_2 also includes a “slice” of system memory 208_1, 208_2 that is coupled to a memory control hub 204_1, 204_2 within its respective platform's processor 202_1, 202_2. As is known in the art, the storage space of system memory is defined by its address space. Here, as a simple example, system memory component 208_1 may be allocated a first range of system memory addresses and system memory component 208_2 is allocated a second, different range of system memory addresses.

With the understanding that applications running on any CPU core in the system can potentially refer to any system memory address, an application that is running on a CPU core within processor 202_1 may not only refer to instructions and/or data in system memory component 208_1 but may also refer to instructions and/or data in system memory component 208_2. In the case of the latter, a system memory request is sent from processor 202_1 to processor 202_2 over link 212. The memory control hub 204_2 of processor 201_1 services the request (e.g., by reading/writing from/to the system memory address within system memory slice 208_2). In the case of a read request, the instruction/data to be returned is sent from processor 202_2 to processor 202_1 over communication link 212.

As observed in FIG. 2, each system memory slice 208_1 is a multi-level system memory solution. For the sake of example, the multi-level system memory of both slices 208_1, 208_2 is observed to include: 1) a first level of system memory 209_1, 209_2; 2) a second level of system memory that may have its own unique address space and/or behave as a memory side cache within system memory 210_1, 210_2; and, 3) a lowest non volatile emerging system memory technology based system memory level 211_1, 211_2.

As just one possible physical implementation of this particular architecture, for instance, first level memory 209_1, 209_2 may be implemented as DRAM devices that are stacked on top of or otherwise integrated in the same semiconductor chip package as their respective processor 202_1, 202_2.

By contrast, second level memory 210_1, 210_2 may reside outside the semiconductor chip of their respective processor 202_1, 202_2. For example, second level memory 201_1, 202_2 may be implemented as DRAM devices disposed on DIMM cards that plug into memory channels that are coupled to their respective processor's memory control hub 204_1, 204_2. Here, the DRAM devices may be given their own system memory address space and therefore act as a second priority region of system memory beneath levels 209_1, 209_2. In this case, the DRAM devices of the second level 210_1, 210_2 being located outside the package of their respective processor 202_1, 202_2 are apt to have longer latencies and will therefore be a slower level of system memory than the first level 209_1, 209_2.

Alternatively, DRAM devices within the second level 210_1, 210_2 may behave as a memory side cache for their respective lower non volatile system memory level 211_1, 211_2. As a further alternative possibility, some portion of the DRAM devices in the second level 210_1, 210_2 may be allocated their own unique system memory address space while another portion of the memory devices in the second level 210_1, 210_2 may be configured to behave as a memory side cache for the lower non volatile system memory level 211_1, 211_2.

### 3.0 Different Performance of Different Memory Levels

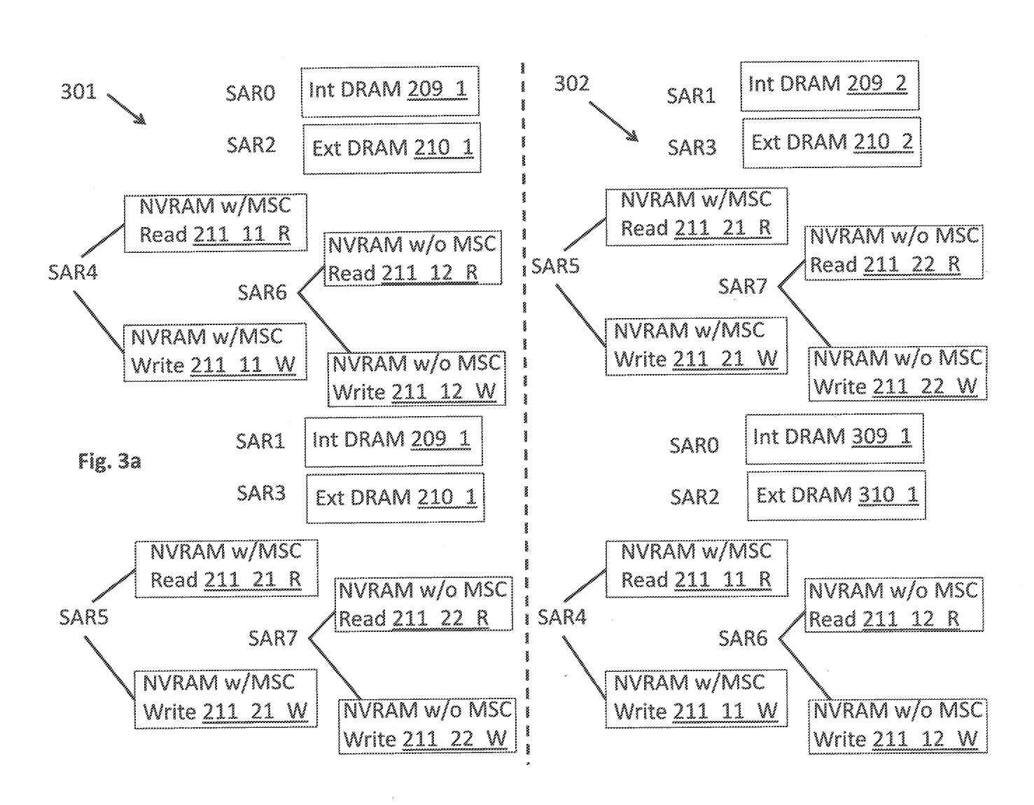

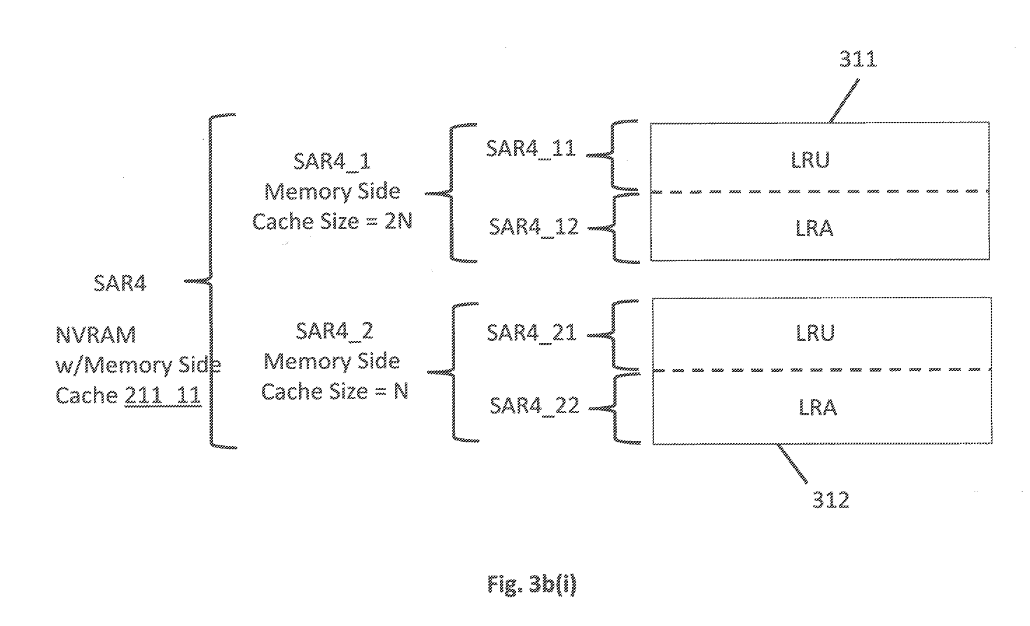

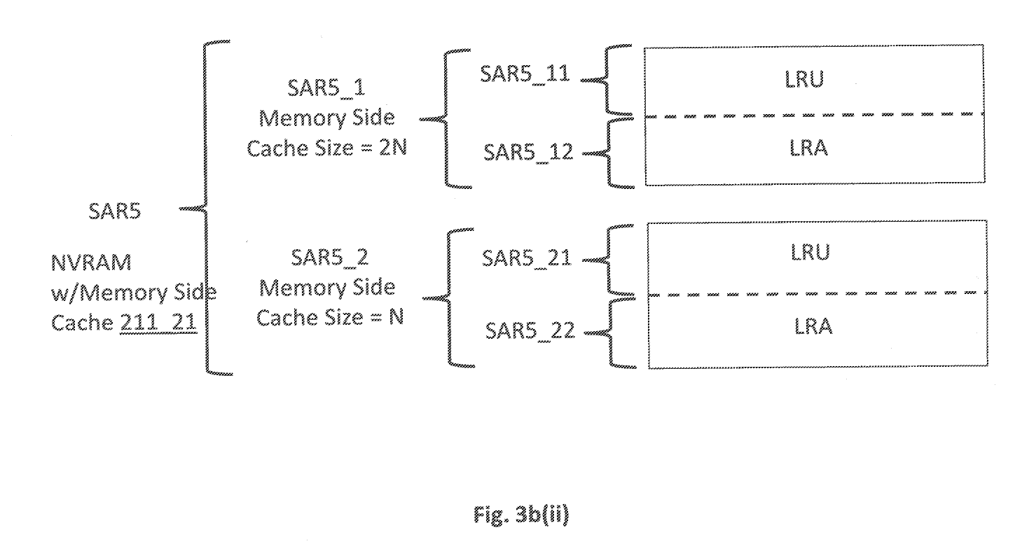

In general, the latency of a system memory component from the perspective of a requestor that issues read and/or write requests to the system memory component (such as an application or operating system instance that is executing on a processing core) is a function of the physical distance between the requestor and the memory component and the technology of the physical memory component. FIG. 3 elaborates on this general property in more detail.

Here, FIG. 3a elaborates on this general property. Column 301 depicts a ranking, in terms of observed speed, of the different system memory components discussed above with respect to FIG. 2 from the perspective of an application that executes on processor 202_1. By contrast, column 302 depicts a ranking, again in terms of observed speed, of the different system memory components discussed above with respect to FIG. 2 from the perspective of an application that executes on processor 202_2. In both columns 301, 302 a higher system memory component will exhibit smaller access times (i.e., will be observed by an application as being faster) than a lower system memory component.

As such, referring to column 301, note that all system memory components 209_1, 210_1, 211_11, 211_12 that are integrated with the platform 301_1 having processor 302_1 are observed to be faster for an application that executes on processor 302_1 than any of the system memory components 309_2, 310_2, 311_21, 311_22 that are integrated with the other platform 301_2. Likewise, referring to column 302, note that all system memory components 209_2, 210_2, 211_21, 211_22 that are integrated with the platform 301_2 having processor 302_2 are observed to be faster for an application that executes on processor 302_2 than any of the system memory components 309_1, 310_1, 311_11, 311_12 that are integrated with the other platform 301_2.

Here, the observed decrease in performance of a system memory component from an off platform application is largely a consequence of link 212. In various embodiments link 212 may correspond to a large physical distance which significantly adds to the propagation delay time of issued requests. Even in the case, however, where the physical distance associated with link 212 is not appreciably large there may nevertheless exist on average noticeable queuing delays associated with placing traffic on the link 212 or receiving traffic from the link 212. Thus, as a general observation, local system memory components will tend to be faster from the perspective of a requestor than more remote system memory components.

This same general trend is also observable with the observed performance rankings within a same platform. That is, within both platforms, the internal DRAM level 209 is higher than the external DRAM level 210. That is, recall that the internal DRAM 209 was integrated in a same semiconductor chip package as its processor 202 whereas the external DRAM 210 was physically located outside the package. Because reaching the external DRAM 210 requires signaling that traverses a longer physical distance, the internal DRAM 210 will exhibit smaller access times than an external DRAM device on the same platform.

FIG. 3a also shows that technology and system architecture can also affect observed latencies of the system memory components and that different latencies may even be observed for read requests and write requests issued to a same memory technology.

With respect to technology, note that the non volatile memory components 211 are slower than the DRAM memory components 209, 210, and, moreover, that with respect to non volatile memory components 211_1, 211_2, write operations can be noticeably slower than read operations. For example, as depicted in FIG. 3a, NVRAM region having a memory side cache 211_11_X (where X can be R or W) exhibits faster speed for reads (depicted with box 211_11_R) than writes (depicted as box 211_1_W). Because reads and writes are targeted to a same memory space, the system address space SAR_4 that is allocated for the NVRAM component having a memory side cache 211_11_X is drawn as being associated with both of its READ and WRITE depictions in FIG. 3a. A similar construction is observed throughout FIG. 3a for NVRAM memory component 211_2.

Although only exemplary, note that reads for an NVRAM technology that does not have a memory side cache (e.g., as represented by box 211_12_R) can be faster than writes to an NVRAM technology having a memory side cache (e.g., as represented by box 211_11_W).

Unlike the NVRAM technology components of FIG. 3a, note that DRAM demonstrates approximately same speed for reads and writes and, as such, the DRAM components of FIG. 3a do not break down into separate boxes for reads and writes.

Apart from generally representing latency, a diagram like FIG. 3a, or one similar to it, can also stand to represent bandwidth as opposed to latency. Here, latency corresponds to the average time (e.g., in micro-seconds) it takes for a request to complete. By contrast, bandwidth corresponds to the average throughput (e.g., in Megabytes/sec) that a particular memory component can support if a constant stream of requests were to be directed to it. Both are directed to the concept of speed but measure it in different ways.

Thus, a system can potentially be characterized with two sets of diagrams that demonstrate the general trends observed in FIG. 3a, a first diagram that delineates based on latency and another diagram that delineates based on bandwidth. For simplicity FIG. 3a only presents one diagram when in reality two separate diagrams could be presented. In practice different applications may be more concerned with one over the other. For example, a first application that does not generate a lot of requests to system memory but whose performance remains very sensitive to how fast its relatively few memory requests will be serviced will be very dependent on latency but not bandwidth so much. By contrast, an application that streams large amounts of requests to system memory will perhaps be as concerned with bandwidth as will latency.

With respect to architecture, note that a non volatile memory component that also has a memory side cache 211_X1 will be comparatively faster than a non volatile memory component that does not have a memory side cache 211_X2_X. That is, reads of a non volatile memory component having a memory side cache will be faster than reads of a non volatile memory component that does not have a memory side cache. Likewise, writes to a non volatile memory component having a memory side cache will be faster than writes to a non volatile memory component that does not have a memory side cache.

Here, FIG. 3a assumes, e.g., that some portion of the external DRAM 209 is given its own unique system memory address space whereas another portion of the external DRAM 209 is used to implement a memory side cache for a portion of the non volatile system memory 211. This particular system memory component level is labeled 211_X1 in FIG. 3a (where X can be 1 or 2).

Another portion of the non volatile system memory 211, labeled in FIG. 3a as 211_X2, does not have any memory side cache service. Thus, whereas requests directed to a 211_X1 memory level are handled according to the near-memory/far-memory semantic behavior described above in the preceding section, by contrast, requests directed to a 211_X2 level are serviced directly from the non volatile memory 211 without any look-up into a near memory. Because the 211_X2 level does not receive any performance speed up from a near memory cache, the 211_X2 level will be observed to be slower than the 211_X1 level.

FIGS. 3b(i) and 3b(ii) elaborate on two other architectural features that can further compartmentalize the different memory components. Referring to FIG. 3b(i), level 211_21 (which exhibits near memory/far memory behavior on platform 201_1) can be further compartmentalized by allocating more or less near memory cache space per amount of far memory space.

Here, as just an example, level 311 provides twice as much near memory cache space per unit of far memory storage space than does level 312. This arrangement can be achieved, as just one example, by having the DRAM DIMMs provide near memory service only to those non volatile memory DIMMs that are plugged into the same memory channel. By having a first memory channel configured with more DRAM DIMMs than a second memory channel where both memory channels have the same number of non-volatile memory DIMMs (or, alternatively, both channels have the same number of DRAM DIMMs but different numbers of non volatile memory DIMMs), different ratios of near memory cache space to far memory space can be effected. Because level 312 has less normalized cache space than level 311, level 312 will be observed as being slower than level 311 and is therefore placed beneath it in the visual hierarchy of FIG. 3b(i).

A second architectural feature is that different near memory cache eviction policies may be instantiated for either of the memory levels 311, 312 of FIG. 3b(i). Here, for instance, the memory control hub 204_1 of platforms 201_1 is designed to implement the near memory for both of levels 311, 312 as a set associative cache or fully associative cache and can therefore evict cache lines from a particular set based on different criteria. For example, if a set is full and a next cache line needs to be added to the set, the cache line that is chosen for eviction may either be the cache line that has been least recently used (accessed) in the set or the cache line that has been least recently added to the set (the oldest cache line in the set).

FIG. 3b(i) therefore shows the already compartmentalized non volatile memory with near memory cache level 211_11 being further compartmentalized into a least recently used (LRU) partition 313 and a least recently added (LRA) partition 314. Note that different software applications may behave differently based on which cache eviction policy is used. That is, some applications may be faster with LRU eviction whereas other applications may be faster with LRA eviction. As described above at the end of section 1.0, various forms of caching may be implemented by the hardware. Some of these, such as direct mapped, may impose a particular type of cache eviction policy such that varying flavors of cache eviction policy are not readily configurable within a same system. In this case, e.g., the breakdown of SAR_4_1 and SAR_4_2 into further sub-levels as depicted in FIG. 3b(i) may not be realizable. For simplicity the remainder of the discussion will assume that different cache eviction policies can be configured.

FIG. 3b(ii) shows that the non volatile memory component having near memory cache 211_21 of the second platform can also be broken down according to the same scheme as observed in FIG. 3b(i).

FIGS. 3a and 3b(i)/(ii) indicate that each of the different system memory levels/partitions can be allocated their own system memory address range.

For example, as depicted in FIG. 3a, the system memory address space of the slice of system memory 208_1 associated with the first platform 201_1 corresponds to a first system address range SAR0 that is allocated to the internal DRAM 209_1 of the first platform 201_1, a second system memory address range SAR2 that is allocated to the portion of the external DRAM 210_1 that is allocated unique system memory address space, a third system memory address range SAR4 that is allocated to the portion of non volatile memory 211_11 that receives near memory cache service and a fourth system memory address range SAR6 that is allocated to the portion of non volatile memory 212_12 that does not receive near memory cache service.

Likewise, the system memory address space of the slice of system memory 208_2 associated with the first platform 201_2 corresponds to a fifth system address range SAR1 that is allocated to the internal DRAM 209_2 of the second platform 201_2, a sixth system memory address range SAR3 that is allocated to the portion of the external DRAM 210_2 that is allocated unique system memory address space, a seventh system memory address range SAR5 that is allocated to the portion of non volatile memory 211_21 that receives near memory cache service and an eighth system memory address range SAR7 that is allocated to the portion of non volatile memory 211_22 that does not receive near memory cache service.

As observed in FIG. 3b(i), the SAR4 portion 211_11 can further be divided into two more ranges SAR4_1 and SAR4_2 to accommodate the two different levels having different normalized caching space. The SAR4_1 and SAR4_2 levels can also each be further divided into two more system memory address ranges (i.e., SAR4_1 can be divided into SAR4_11 and SAR4_21, and, SAR4_2 can be divided into SAR4_21 and SAR4_22) to accommodate the different cache eviction partitions of levels 211_11 and 211_21, respectively.

For ease of drawing, neither of FIGS. 3b(i) and 3b(ii) distinguish between read speed and write speed. Here, for instance, for the same address space, regions 311 and 312 of FIG. 3b(i) could be further split to show different speeds for reads and writes. A similar enhancement could be made to FIG. 3b(ii).

### 4.0 Exposing Different System Memory Levels/Partitions To Software To Enable Configuration Of Different Performance Levels For Different Software Applications

With all the different levels/partitions that the system memory can be broken down into, and all the different performance dependencies (e.g., reads vs. writes) different software applications can be assigned to operate out of the different system memory levels/partitions in accordance with their actual requirements or objectives. For instance, if a first application (e.g., a video streaming application) would better serve its objective by executing faster, then, the first application can be allocated a memory address space that corresponds to a lower latency read time and higher read bandwidth system memory portion, such as the internal and/or external DRAM portions 209, 210 of the same platform that the application executes from (i.e., the higher ranked memory components in FIG. 3a), or, perhaps one or both the NVRAM levels (with memory side cache and without memory side cache).

By contrast, if a second application (e.g., an archival data storage application) does not necessarily need to operate with the fastest of speeds, the second application can be allocated a memory address space that corresponds to a higher latency read or write time and lower read or write bandwidth system memory portion, such as one of the non volatile memory portions of its local platform or even a remote platform.

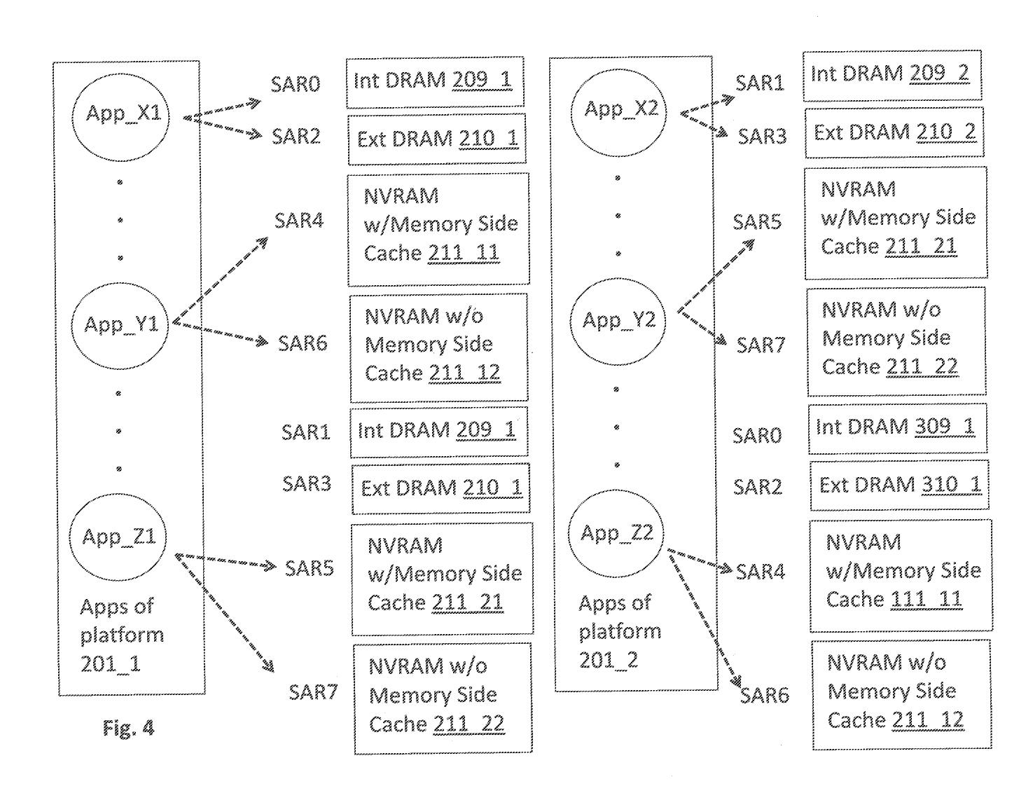

FIG. 4 shows a general approach to assigning certain applications (or other software components) that execute on the system of FIG. 2 to certain appropriate system memory levels/partitions in view of the applications' desired performance level. For simplicity, FIG. 4 and the example described herein does not contemplate different speed metrics (e.g., latency vs. bandwidth) nor differences in read or write performance.

Here, the applications that run on platform 201_1 can, e.g., be ranked in terms of desired performance level. FIG. 4, shows a simplistic continuum of the applications that run on platform 201_1 based on their desired performance level. Here, application X1 has a highest desired performance level, application Y1 has a medium desired performance level and application Z1 has a lowest desired performance level.

As such, application X1 is allocated memory address ranges SAR0 and/or SAR2 to cause application X1 to execute out of either or both of the memory components 209_1, 210_1 that have the lowest latency for an application that runs on platform 201_1. By being configured to operate out of the fastest memory available to application X1, application X1 should demonstrate higher performance.

By contrast, application Y1 is allocated memory address ranges SAR4 and/or SAR6 to cause application Y1 to execute out of either or both of the memory components 211_11, 211_12 that have modest latency for an application that runs on platform 201_1. By being configured to operate out of a modest latency memory that is available to application Y1, application Y1 should demonstrate medium performance.

Further still, application Z1 is allocated memory address ranges SAR5 and/or SAR7 to cause application Z1 to execute off platform out of either or both of memory components 209_2, 210_2 which not only reside on platform 201_2 but are also the higher latency memories on platform 201_2. By being configured to operate out of the slowest memory available to application Z1, application Z1 should demonstrate lowest performance.

An analogous configuration is also observed in FIG. 4 for applications X2, Y2 and Z2 that execute from platform 201_1. Note that the configurations depicted in FIG. 4 are somewhat simplistic in that each application is configured to operate out of no more than two different memory components, and, both memory components are contiguous on the memory latency scale. Other embodiments may configure an application to execute out of more than two memory components. Further still, such memory components need not be contiguous on the memory latency scale. FIG. 4 is also simplistic in that either of applications Y1 and Y2 could be configured to operate out of less than all of the narrower system memory addresses discussed in FIGS. 3b(i) and 3b(ii), respectively.

Here, an application's execution from a particular platform may actually be implemented by executing its program code on a particular processing core of the platform. As such, the application's software thread and its associated register space is physically realized on the core even though its memory accesses may be directed to some other platform. Multi-threaded applications can execute on a same core, different cores of a same platform or possibly even different cores of different platforms.

In order to configure a computing system such that its applications will execute out of an appropriate one or more levels of system memory, an operating system instance and/or virtual machine monitor will need some visibility into the different system memory levels and their latency relationship with the different processing cores of the system.

It is pertinent to point out, however, that the above configuration examples could be enhanced to contemplate difference speed metrics (such as latency v. bandwidth) or different read and write latencies/bandwidths. Here, system configuration information could contemplates different latencies and bandwidths for both read and writes for the various memory components and configure the various applications to operate out of certain ones of the different memory components whose characteristics were a good fit from a behavior/performance perspective.

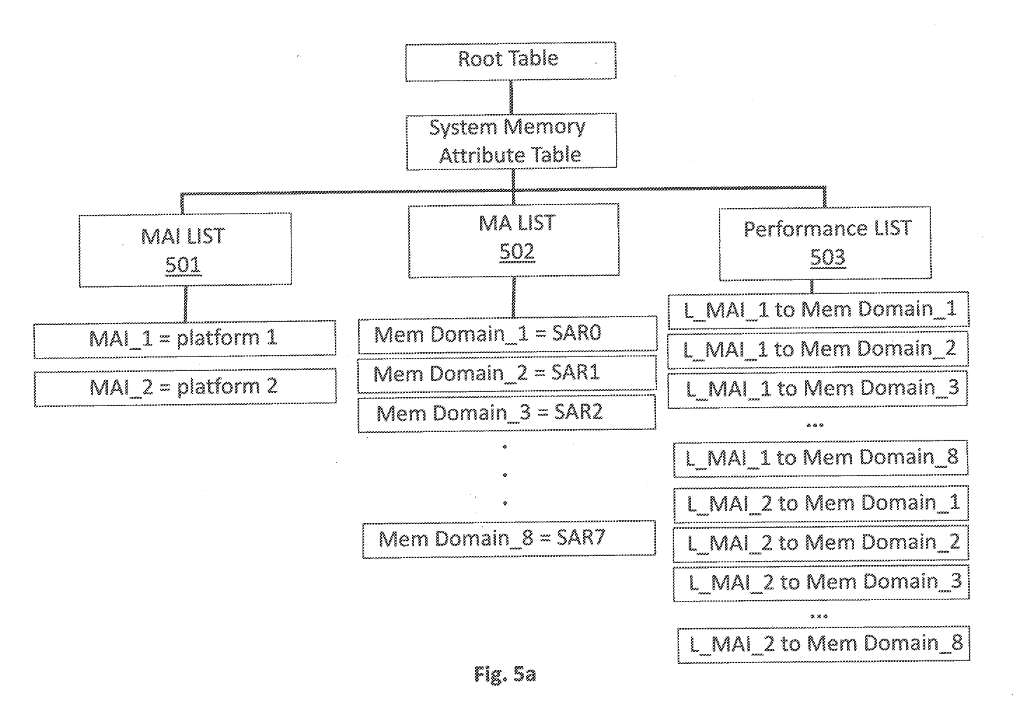

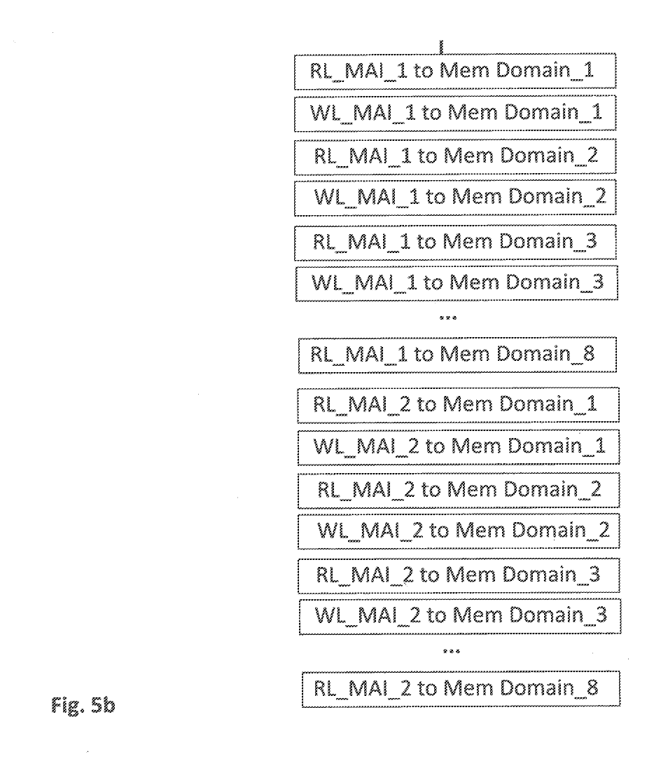

FIG. 5a shows an exemplary root complex that could, e.g., be loaded into a computing system's BIOS and referred to by an OS/VMM during system configuration. Here, the root complex includes a System Memory Attribute Table (which could be defined by another name) that lists in a first list 501 the different entities, referred to as memory access initiators (MAIs), that can issue a read or write request to system memory. In the exemplary system of FIG. 2 these included a first platform 201_1 (“platform_1” in FIG. 5a) and a second platform 201_2 (“platform_2” in FIG. 5a).

Note that the list 501 and overall root complex may take the form of a directory rather than just a collection of lists. For example, each platform entry in the MAI list 501 may act as a higher level directory node that further lists its constituent CPU cores within/beneath it.

Further still, any kind of entity that issues a request to system memory can have its entry or node in the MAI list with further sub nodes listing its constituent parts that can individually issue system memory requests. For example, an I/O control hub node can further list its various PCIe interfaces as sub nodes. Each of the various PCIe interfaces can list the corresponding devices that connected to it as further sub-nodes of the PCIe interface subnodes. Similar structures can be composed for mass storage devices (e.g., disk drives, solid state drives).

Here, any component that can issue a read or write request to system memory (e.g. a network interface, a mass storage device, a CPU core) can be given MAI status and assigned a region of system memory space. As discussed at length above, a CPU core is assigned system memory space for its software to execute out of. Thus, not only may a CPU core be recognized as an MAI entry within the list, but also, e.g., each application that is configured to run on a particular CPU core may be given MAI status and listed in the MAI list 501.

By contrast, I/O devices may or may not execute software but nevertheless may issue system memory read/write requests. For instance, a network interface may stream the data it receives from a network into system memory and/or receive from system memory the data it is streaming into a network. Again, the notion that higher performance components can be allocated higher performance levels of system memory still applies. For example, a first network interface that is coupled to a high bandwidth link may be coupled to a higher performance system memory level while a second network interface that is coupled to a low bandwidth link may be coupled to a lower performance system memory level. An analogous arrangement can be applied with respect to faster performance mass storage devices and slower performance mass storage devices.

Thus, each MAI entry in the MAI list 501 may include some further meta data information that describes or otherwise indicates its performance level so that an operating system instance and/or virtual machine monitor can comprehend the appropriate level of system memory performance that it will need. CPU core entries and/or the applications that run on them can include similar meta data.

A second list 502 lists the different memory access (“MA”) regions or domains within the system memory that can be separately identified. The MAI list 502 of FIG. 5a simplistically only lists the eight different memory levels observed in FIG. 3a. However, consistent with the discussion just above that the overall root complex may take the form of a directory, certain memory levels/domains may be further expanded upon to show different performance levels within itself. For example, the memory domains that correspond to a non volatile memory region having near memory cache service may further be broken down in the root complex to reflect the structures of FIGS. 3(b)(i) and 3(b)(ii). As such, the root complex can show the different performance (more/less near memory cache space) or behavior (LRU/LRA) within system memory with various levels of granularity.

Again, each node in the MA list 502, besides identifying its specific system memory address range, may include some meta data that describes attributes of itself such as technology type (e.g., DRAM/non volatile), associated access speed and architecture (e.g., 2LM with a specific amount of near memory cache space and cache eviction policy). An OS instance or virtual machine monitor can therefore refer to this information when attempting to configure a certain memory access initiator with a specific memory domain.

The root complex of FIG. 5a also includes a performance list 503 that lists each of the different logical connections that can exist from each of the memory initiators to each of the different memory access domains and identifies an estimated or approximate latency for each logical connection. Here, again FIG. 5a is simplistic in that it only lists all sixteen such logical connections depicted in FIGS. 3a and 4 (eight for application that run on platform 201_1 and eight for applications that run on platform 201_1). Here, a logical connection on a same platform will largely be based on system memory technology and architectural implementation of the system memory (e.g., 2LM or not 2LM) whereas a logical connection that spans across platforms will be based not only on technology implementation of the system memory level but also networking latency associated with the inter platform communication that occurs over a link/network.

FIG. 5b shows a slightly more comprehensive performance list than the simplistic latency list 503 of FIG. 5b. In particular, the performance list 503 of FIG. 5a could be expanded to separate read latencies from write latencies for each of the different memory components. Here, read latency entries are denoted “RL_ . . . ” whereas write latency entries are denoted “WL . . . ”. As such, configuration software can better align applications that have a greater tendency or sensitivity to one or other type of access (read or write) by studying links between entries in the expanded performance list with entries in the MAI list 501.

Here, a DRAM component having its own address space may present same read and write latency metadata whereas any of the NVRAM components may present substantially different read and write latency data.

Further still, the performance list of FIG. 5b could even be further extended to include bandwidth in addition to latencies for each memory domain, and, further still, to show different read bandwidth and different write bandwidth meta data for each of the different memory domains.

Returning to FIG. 5a, once all information from each the MAI 501, MA 502 and performance 503 lists are presented, an operating system instance or virtual machine monitor can synthesize the information and begin to assign/configure specific memory access initiators with specific memory access domains where the particular assignment/configuration between a particular memory access initiator in list 501 and a particular memory domain in list 502 is based on an appropriate read/write latency and/or read/write bandwidth between the two that is recognized from list 503. In particular, if a first application requires high read bandwidth but not high write bandwidth, the application may be assigned to operate out of memory domain that corresponds to an underlying memory technology that has much faster read bandwidth than write bandwidth (e.g., an emerging non volatile memory technology). By contrast, a second application that requires approximately the same low latency for both reads and writes may be assigned to operate out of a higher performance memory that has approximately same read/write latency (e.g., DRAM).

The root complex approach described just above may be written to be compatible with any of a number of system and/or component configuration specifications (e.g., Advanced Configuration and Power Interface (ACPI), NVDIMM Firmware Interface Table (NFIT)). Here, again, the root table may be stored in non volatile BIOS and used by configuration software during a configuration operation (e.g., upon boot-up, in response to component addition/removal, etc.). Conceivably, current versions of SLIT and/or SRAT information (discussed in the background) could be expanded to include the attribute features described just above with respect to the root complex of FIG. 5.

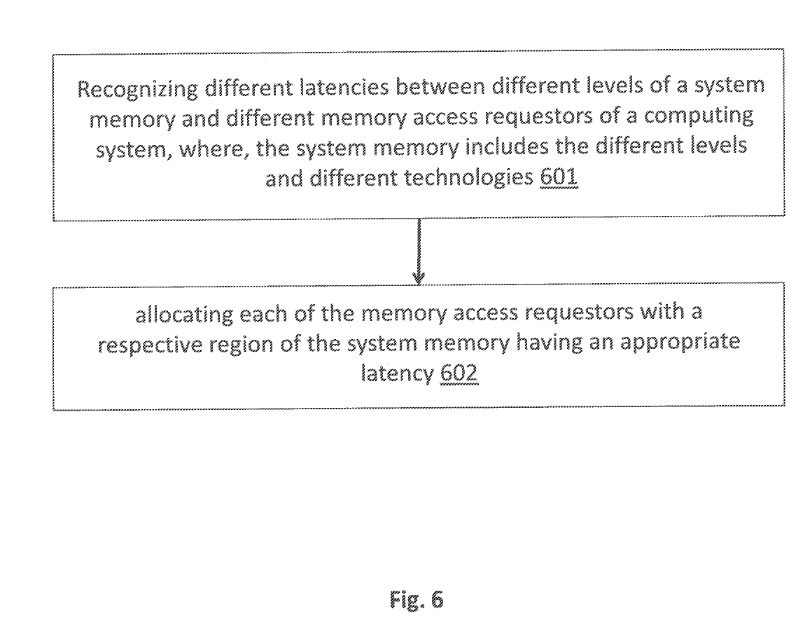

FIG. 6 shows a method described in the preceding sections. The method includes recognizing different latencies between different levels of a system memory and different memory access requestors of a computing system, where, the system memory includes the different levels and different technologies 601. The method also includes allocating each of the memory access requestors with a respective region of the system memory having an appropriate latency 602.

### 5.0 Computing System Embodiments

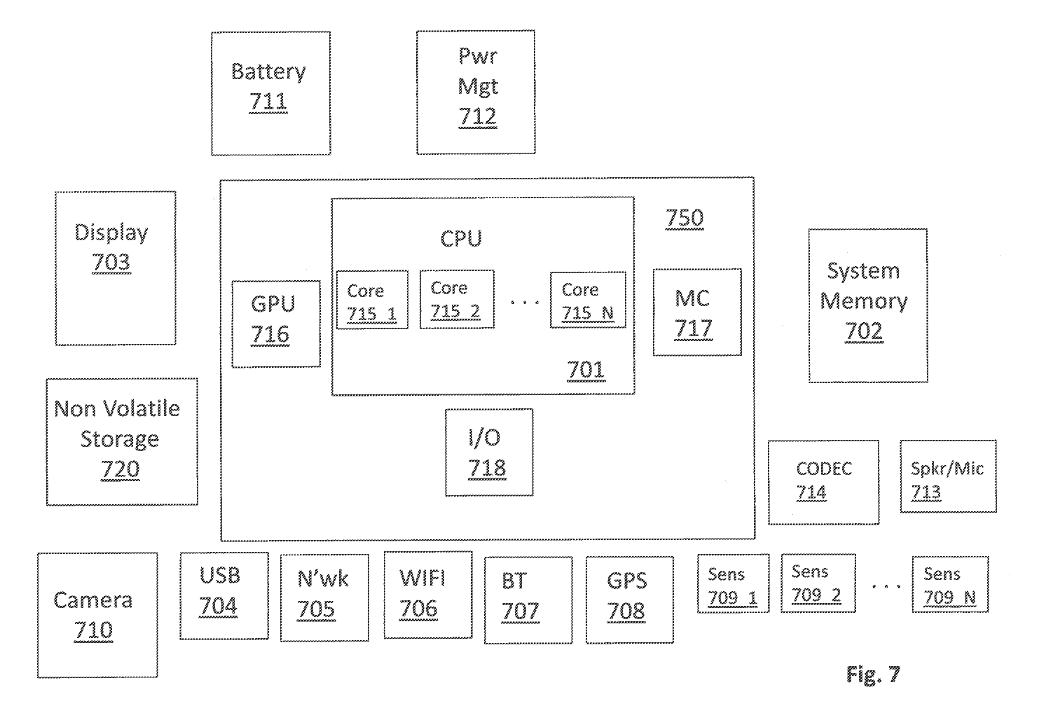

FIG. 7 shows a depiction of an exemplary computing system 700 such as a personal computing system (e.g., desktop or laptop) or a mobile or handheld computing system such as a tablet device or smartphone, or, a larger computing system such as a server computing system. In the case of a large computing system, various one or all of the components observed in FIG. 7 may be replicated multiple times to form the various platforms of the computer which are interconnected by a network of some kind.

As observed in FIG. 7, the basic computing system may include a central processing unit 701 (which may include, e.g., a plurality of general purpose processing cores and a main memory controller disposed on an applications processor or multi-core processor), system memory 702, a display 703 (e.g., touchscreen, flat-panel), a local wired point-to-point link (e.g., USB) interface 704, various network I/O functions 705 (such as an Ethernet interface and/or cellular modem subsystem), a wireless local area network (e.g., WiFi) interface 706, a wireless point-to-point link (e.g., Bluetooth) interface 707 and a Global Positioning System interface 708, various sensors 709_1 through 709_N (e.g., one or more of a gyroscope, an accelerometer, a magnetometer, a temperature sensor, a pressure sensor, a humidity sensor, etc.), a camera 710, a battery 711, a power management control unit 712, a speaker and microphone 713 and an audio coder/decoder 714.

An applications processor or multi-core processor 750 may include one or more general purpose processing cores 715 within its CPU 701, one or more graphical processing units 716, a memory management function 717 (e.g., a memory controller) and an I/O control function 718. The general purpose processing cores 715 typically execute the operating system and application software of the computing system. The graphics processing units 716 typically execute graphics intensive functions to, e.g., generate graphics information that is presented on the display 703. The memory control function 717 interfaces with the system memory 702. The system memory 702 may be a multi-level system memory and the BIOS of the system may contain attributes of the system memory as discussed at length above so that configuration software can configure certain memory access initiators with specific components of the system memory that have an appropriate latency from the perspective of the initiators.

Each of the touchscreen display 703, the communication interfaces 704-707, the GPS interface 708, the sensors 709, the camera 710, and the speaker/microphone codec 713, 714 all can be viewed as various forms of I/O (input and/or output) relative to the overall computing system including, where appropriate, an integrated peripheral device as well (e.g., the camera 710). Depending on implementation, various ones of these I/O components may be integrated on the applications processor/multi-core processor 750 or may be located off the die or outside the package of the applications processor/multi-core processor 750.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of software or instruction programmed computer components or custom hardware components, such as application specific integrated circuits (ASIC), programmable logic devices (PLD), digital signal processors (DSP), or field programmable gate array (FPGA).

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
recognizing different latencies and/or bandwidths between different levels of a system memory and different memory access requestors of a computing system, the system memory comprising the different levels and different technologies; and,
allocating each of the memory access requestors with a respective region of the system memory having an appropriate latency and/or bandwidth.

2. The method of claim 1 wherein the different technologies comprise DRAM and an emerging non volatile memory technology.

3. The method of claim 2 wherein the emerging non volatile memory technology comprises chalcogenide.

4. The method of claim 1 wherein the different latencies and/or bandwidths further comprise different latencies and/or bandwidths between a read operation and a write operation.

5. The method of claim 1 wherein the different levels of the system memory comprises a level that is integrated in a same semiconductor chip package as a processor having CPU cores.

6. The method of claim 1 wherein the recognizing further comprises analyzing attributes of the different levels of the system memory from a record kept in BIOS of the computing system.

7. The method of claim 6 wherein the attributes are compatible with any of the following standards:
ACPI;
NVDIMM.

8. A machine readable storage medium having contained thereon program code that when processed by a computing system causes the computing system to perform a method, comprising:
recognizing different latencies and/or bandwidths between different levels of a system memory and different memory access requestors of a computing system, the system memory comprising the different levels and different technologies; and,
allocating each of the memory access requestors with a respective region of the system memory having an appropriate latency and/or bandwidth.

9. The machine readable storage medium of claim 8 wherein the different technologies comprise DRAM and an emerging non volatile memory technology.

10. The machine readable storage medium of claim 9 wherein the emerging non volatile memory technology comprises chalcogenide.

11. The machine readable storage medium of claim 8 wherein the different latencies and/or bandwidths further comprise different latencies and/or bandwidths between a read operation and a write operation.

12. The machine readable storage medium of claim 8 wherein the different levels of the system memory comprises a level that is integrated in a same semiconductor chip package as a processor having CPU cores.

13. The machine readable storage medium of claim 8 wherein the recognizing further comprises analyzing a attributes of the different levels of the system memory from a record kept in BIOS of the computing system.

14. The machine readable storage medium of claim 13 wherein the attributes are compatible with any of the following standards:
ACPI;
NVDIMM.

15. A computing system, comprising:
a processor comprising a plurality of computing cores;
a memory control hub;
a system memory coupled to the memory control hub, the system memory comprising different levels and different technologies;
a non volatile storage component that stores BIOS information of the computing system, the BIOS information further comprising respective latency and/or bandwidth attributes of the different levels of the system memory;
a machine readable medium containing program code that when processed by the computing system causes the computing system to perform a method, comprising:
recognize different latencies and/or bandwidths between the different levels of the system memory and different memory access requestors of the computing system; and,
allocate each of the memory access requestors with a respective region of the system memory having an appropriate latency and/or bandwidth based on the BIOS information.

16. The computing system of claim 15 wherein the different technologies comprise DRAM and an emerging non volatile memory technology.

17. The computing system of claim 16 wherein the emerging non volatile memory technology comprises chalcogenide.

18. The computing system of claim 15 wherein the different latencies and/or bandwidths further comprise different latencies and/or bandwidths between a read operation and a write operation.

19. The computing system of claim 15 wherein the different levels of the system memory comprises a level that is integrated in a same semiconductor chip package as a processor having CPU cores.

20. The computing system of claim 15 wherein the attributes are compatible with any of the following standards:
ACPI;
NVDIMM.

21. The computing system of claim 15 further comprising at least one of:
a display;
a networking interface; or
a battery.
